(19) United States
(12) Patent Application Publication
(10) Pub. No.: US 2018/0204500 A1
(43) Pub. Date: Jul. 19, 2018

(54) METHOD AND DEVICE FOR ENHANCING CONTRAST

(71) Applicant: Beijing Xiaomi Mobile Software Co., Ltd., Beijing (CN)

(72) Inventor: Guosheng LI, Beijing (CN)

(73) Assignee: Beijing Xiaomi Mobile Software Co., Ltd., Beijing (CN)

(21) Appl. No.: 15/874,646

(22) Filed: Jan. 18, 2018

(30) Foreign Application Priority Data
Jan. 19, 2017 (CN) 201710039396.4

(51) Int. Cl. G09G 3/20

(52) U.S. Cl. CPC G09G 3/2007; G09G 2320/066; G09G 2360/144; G09G 2354/00; G09G 2320/0233; G09G 2320/0626

(57) ABSTRACT

A method and a device for enhancing contrast are provided. According to an example, the method includes: determining gray scale distribution information of a picture to be displayed on a mobile device when the mobile device operates in a preset display mode, where, in the preset display mode, the mobile device has a screen luminance that is lower than a preset luminance threshold; determining a contrast adjustment curve of the picture to be displayed according to the gray scale distribution information; and enhancing contrast of the picture to be displayed according to the contrast adjustment curve.

### CROSS REFERENCE TO RELATED APPLICATIONS

This application claims priority to Chinese Patent Application No. 201710039396.4, filed on Jan. 19, 2017, the entire content of which is incorporated herein by reference for all purposes.

### TECHNICAL FIELD

The present disclosure relates to methods and devices for enhancing contrast.

### BACKGROUND

Display screens may be applied to different mobile devices, such as mobile phones, MP3/MP4, wearable devices, tablet computers and on the like. With wide application of different mobile devices, people have high requirements for contrast of a displayed picture on a display screen. In an example, the contrast of the displayed picture on the display screen of the mobile device may be preset. It may be difficult to automatically adjust the contrast of the displayed picture on the display screen of the mobile device. For example, where a screen luminance is lower than 5 nits, people may care much more about visibility than displayed details. If the contrast of the displayed picture cannot be enhanced, content in the displayed picture may be blurred. The readability of the content in the displayed picture may be reduced.

### SUMMARY

The present disclosure provides a method and a device for enhancing contrast.

According to a first aspect of the present disclosure, a method of enhancing contrast is provided. The method may include: determining gray scale distribution information of a picture to be displayed on a mobile device when the mobile device operates in a preset display mode, where, in the preset display mode, the mobile device has a screen luminance that is lower than a preset luminance threshold; determining a contrast adjustment curve of the picture to be displayed according to the gray scale distribution information; and enhancing contrast of the picture to be displayed according to the contrast adjustment curve.

According to a second aspect of the present disclosure, a device for enhancing contrast is provided, the device may include: a processor; and a non-transitory machine-readable storage medium storing instructions are executable by the processor. The processor may be configured to determine gray scale distribution information of a picture to be displayed on a mobile device when the mobile device operates in a preset display mode, where, in the preset display mode, the mobile device may have a screen luminance that is lower than a preset luminance threshold; determine a contrast adjustment curve of the picture to be displayed according to the gray scale distribution information; and enhance contrast of the picture to be displayed according to the contrast adjustment curve.

It shall be appreciated that the forgoing general descriptions and the following detailed descriptions are merely illustrative and explanatory, and are not limiting to the present disclosure.

### BRIEF DESCRIPTION OF DRAWINGS

The accompanying drawings, which are incorporated in and constitute a part of the present specification, illustrate examples consistent with the present disclosure and serve to explain the principles of the present disclosure together with the specification.

FIG. 1 is a flowchart illustrating a method of enhancing contrast according to an example of the present disclosure.

FIG. 2A is a flowchart illustrating a method of enhancing contrast according to an example of the present disclosure.

FIG. 2B is a flowchart illustrating block 201 according to an example of the present disclosure.

FIG. 2C is a flowchart illustrating block 201 according to another example of the present disclosure.

FIG. 3A is a flowchart illustrating a method of determining a contrast adjustment curve based on gray scale distribution information according to an example of the present disclosure.

FIG. 3B is a schematic diagram illustrating a contrast adjustment curve according to an example of the present disclosure.

FIG. 3C is a schematic diagram illustrating a contrast adjustment curve according to another example of the present disclosure.

FIG. 3D is a schematic diagram illustrating a contrast adjustment curve according to still another example of the present disclosure.

FIG. 4 is a flowchart illustrating a method of setting contrast adjustment curves corresponding to different dominant gray scale ranges according to an example of the present disclosure.

FIG. 5 is a block diagram illustrating a device for enhancing contrast according to an example of the present disclosure.

FIG. 6 is a block diagram illustrating a device for enhancing contrast according to another example of the present disclosure.

FIG. 7 is a diagram illustrating a hardware structure of a device for enhancing contrast according to an example of the present disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples of the present disclosure. Also, common but well-understood elements that are useful or necessary in a commercially feasible example are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above, except where different specific meanings have otherwise been set forth herein.

### DETAILED DESCRIPTION

Exemplary embodiments will be described in detail herein with the examples thereof expressed in the drawings. When the following descriptions involve the drawings, like numerals in different drawings represent like or similar elements unless stated otherwise. The implementations described in the following exemplary embodiments do not represent all implementations consistent with the present disclosure. On the contrary, they are merely examples of a device and a method consistent with some aspects of the present disclosure described in detail in the appended claims.

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” and the like may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

FIG. 1 is a flowchart illustrating a method of enhancing contrast according to an example of the present disclosure. The method of enhancing contrast may be applied to a mobile device such as a tablet computer, a smart phone, or a smart camera. As shown in FIG. 1, the method of enhancing contrast may include the following blocks.

At block 101, gray scale or level distribution information of a picture to be displayed with a mobile device may be determined when the mobile device operates in a preset display mode.

In an example, a preset display mode, for example, a night light display mode, may indicate that a screen luminance is lower than a preset luminance threshold. For example, content in the picture to be displayed may be less visible in the preset display mode when the screen luminance is lower, for example, below 6 nits.

In an example, the picture to be displayed may be interpreted as content to be displayed on a screen, for example, an image to be displayed on the screen.

In an example, the gray scale distribution information of the picture to be displayed may be interpreted as a gray scale distribution characteristic of pixels of the picture to be displayed, for example, there are more pixels having lower gray scales, or there are more pixels having gray scales ranging from 135 to 195 in the picture to be displayed.

At block 102, a contrast adjustment curve of the picture to be displayed is determined according to the gray scale distribution information.

To better enhance the contrast of the picture to be displayed, the contrast adjustment curve may maximize a gray scale adjustment slope of pixels within a dominant gray scale range. For example, there are more pixels having low gray scales, such as pixels having gray scales from 5 to 10, in the picture to be displayed while there are very few pixels having high gray scales, such as pixels having gray scales from 200 to 255. In this case, the contrast of the picture to be displayed may be improved by enhancing the contrast of the pixels having the gray scales from 5 to 10.

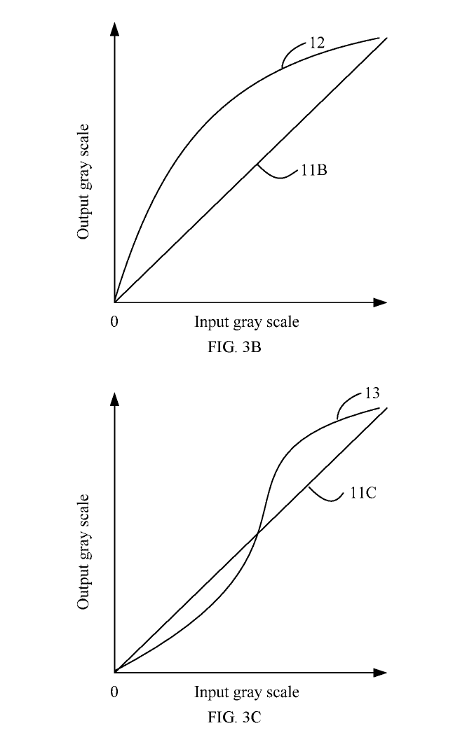

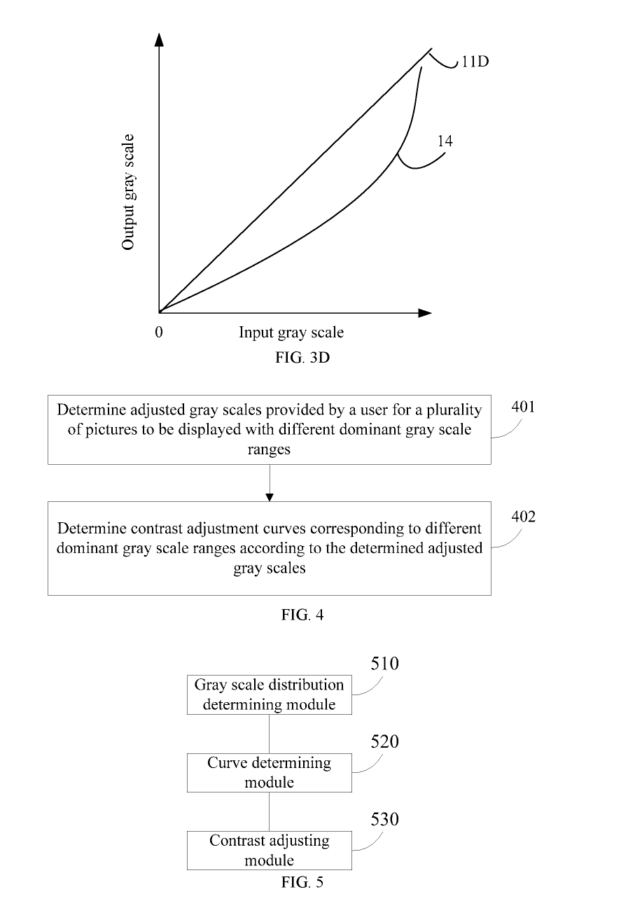

The process of determining the contrast adjustment curve of the picture to be displayed may be referred to an example shown in FIG. 3A, which is not described in detail here.

At block 103, the contrast of the picture to be displayed is enhanced according to the contrast adjustment curve.

A gray scale of a pixel of the picture to be displayed may be taken as an input gray scale firstly, and a corresponding output gray scale may be then determined according to the input gray scale in the contrast adjustment curve. Then the gray scale of the pixel may be adjusted to be the corresponding output gray scale, so as to enhance the contrast of the picture to be displayed.

In this example, when the mobile device operates in the preset display mode, for example, in a night light display mode where the screen luminance is lower than the preset luminance threshold, the contrast adjustment curve of the picture to be displayed may be automatically determined to enhance the contrast of the picture to be displayed, thereby effectively improving readability of the displayed content.

In an example, the above method of enhancing contrast may also include: detecting ambient light luminance; and controlling the mobile device to switch to the preset display mode when the ambient light luminance is lower than preset ambient light luminance.

In an example, the above method of enhancing contrast may also include receiving a preset switching operation triggered by a user through a physical button or a touch screen of the mobile device; and controlling the mobile device to switch to the preset display mode based on the preset switching operation.

In an example, determining the gray scale distribution information of the picture to be displayed may include: analyzing a histogram of the picture to be displayed; determining a plurality of gray scale ranges in the picture to be displayed; and determining a pixel number ratio of each of the plurality of gray scale ranges in the picture to be displayed according to the histogram, so as to obtain the gray scale distribution information of the picture to be displayed. Where, the pixel number ratio of the gray scale range is a ratio of a number of pixels having gray scale within the gray scale range with respect to a total number of pixels in the picture to be displayed.

In an example, determining the contrast adjustment curve of the picture to be displayed based on the gray scale distribution information may include: determining at least one of the gray scale ranges of which the pixel number ratio are greater than a preset ratio threshold as a dominant gray scale range; and determining the contrast adjustment curve of the picture to be displayed according to the dominant gray scale range. Where a horizontal axis of the contrast adjustment curve may represent an input gray scale, a vertical axis of the contrast adjustment curve may represent an output gray scale and a curve slope of the contrast adjustment curve in the dominant gray scale range is greater than a curve slope in a non-dominant gray scale range.

Enhancing the contrast of the picture to be displayed according to the contrast adjustment curve may include: taking a gray scale of each of the pixels of the picture to be displayed as an input gray scale; determining an output gray scale corresponding to each of the pixels according to the input gray scale in the contrast adjustment curve; and adjusting the gray scale of each of the pixels to be the determined corresponding output gray scale to enhance the contrast of the picture to be displayed.

In an example, determining the contrast adjustment curve of the picture to be displayed according to the dominant gray scale range may include: when the dominant gray scale range is determined as a first gray scale range, determining the contrast adjustment curve of the picture to be displayed as a first contrast adjustment curve. Where, gray scales in the first gray scale range are lower than gray scales in other gray scale ranges. The first contrast adjustment curve is above a reference curve of which a slope is equal to 1 and shaped into an arc bending toward the reference curve. Moreover, when the input gray scale is smaller than a first threshold, a slope of the first contrast adjustment curve increases as the input gray scale increases. When the input gray scale is greater than the first threshold, the slope of the first contrast adjustment curve decreases as the input gray scale increases.

In an example, determining the contrast adjustment curve of the picture to be displayed according to the dominant gray scale range may include: when the dominant gray scale range is determined as a second gray scale range, determining the contrast adjustment curve of the picture to be displayed as a second contrast adjustment curve. Where, gray scales in the second gray scale range are higher than gray scales in some gray scale ranges and lower than gray scales in other some gray scale ranges. The second contrast adjustment curve is below a reference curve of which a slope is equal to 1 and shaped into an arc bending toward the reference curve when the input gray scale is smaller than a second threshold, and above the reference curve and shaped into an arc bending toward the reference curve when the input gray scale is greater than the second threshold. When the second contrast adjustment curve is below the reference curve, a slope of the second contrast adjustment curve may increase as the input gray scale increases. When the second contrast adjustment curve is above the reference curve, the slope of the second contrast adjustment curve may decrease as the input gray scale increases.

In an example, determining the contrast adjustment curve of the picture to be displayed according to the dominant gray scale range may include: when the dominant gray scale range is determined as a third gray scale range, determining the contrast adjustment curve of the picture to be displayed as a third contrast adjustment curve. Where, gray scales in the third gray scale range are higher than gray scales in other gray scale ranges. The third contrast adjustment curve is below a reference curve of which a slope is equal to 1 and shaped into an arc bending toward the reference curve. Moreover, when the input gray scale is smaller than a third threshold, a slope of the third contrast adjustment curve increases as the input gray scale increases. When the input gray scale is greater than the third threshold, the slope of the third contrast adjustment curve decreases as the input gray scale increases.

How to enhance the contrast will be described in detail in the following examples.

According to the above methods provided by examples of the present disclosure, a contrast adjustment curve of a picture to be displayed may be automatically determined to enhance the contrast of the picture to be displayed, thereby effectively improving the readability of the displayed content.

The technical solutions provided by an example of the present disclosure will be described below with an example.

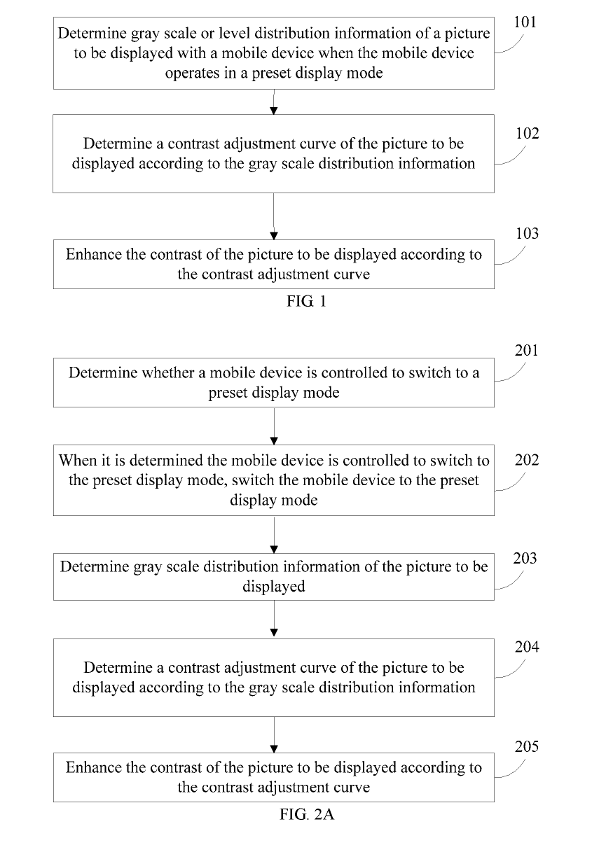

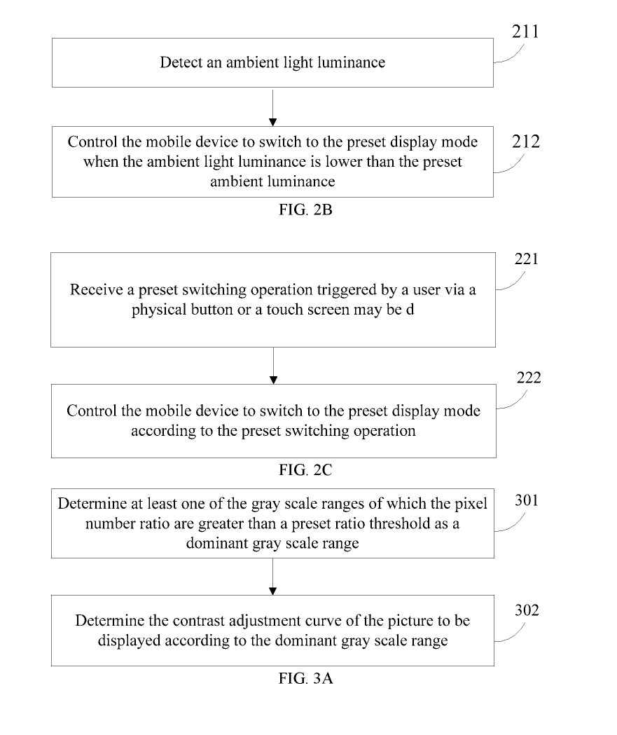

FIG. 2A is a flowchart illustrating a method of enhancing contrast according to an example of the present disclosure. FIG. 2B is a flowchart illustrating block 201 according to an example of the present disclosure. FIG. 2C is a flowchart illustrating block 201 according to another example of the present disclosure. As shown in FIG. 2A, the method of enhancing contrast may include the following blocks.

At block 201, it is determined whether a mobile device is controlled to switch to a preset display mode.

In an example, it may be determined whether the mobile device is controlled to switch to the preset display mode according to an ambient light luminance. As shown in FIG. 2B, block 201 may include the following blocks.

At block 211, an ambient light luminance may be detected.

At block 212, the mobile device may be controlled to switch to the preset display mode when the ambient light luminance is lower than the preset ambient luminance.

In an example, the preset ambient luminance may be a relatively low light luminance, for example, 2 cd/m². The display mode of the mobile device may be switched to the present display mode, for example, a display mode without irritation to human eyes, in an environment where the ambient light luminance is relatively low.

In another example, it may be determined whether the mobile device is controlled to switch to the preset display mode based on whether a preset switching operation triggered by a user is received. As shown in FIG. 2C, block 201 may include the following blocks.

At block 221, a preset switching operation triggered by a user via a physical button or a touch screen may be received.

In an example, the preset switching operation may be an instruction of the user to switch the mobile device to the preset display mode for operating. For example, the preset switching operation may be triggered by pressing a volume button on the right side of the mobile device for 2 seconds.

At block 222, the mobile device may be controlled to switch to the preset display mode according to the preset switching operation.

At block 202, when it is determined the mobile device is controlled to switch to the preset display mode, the mobile device may be switched to the preset display mode.

At block 203, gray scale distribution information of the picture to be displayed may be determined.

In an example, a pixel number ratio of each of the plurality of preset gray scale ranges in the picture to be displayed may be determined by analyzing a histogram of the picture to be displayed, so as to obtain the gray scale distribution information of the picture to be displayed. Where, the pixel number ratio of the gray scale range is a ratio of a number of pixels having gray scale within the gray scale range in the picture to be displayed with respect to a total number of pixels in the picture to be displayed. For example, it is assumed that the preset gray scale ranges in the picture to be displayed include: a low gray scale range having gray scales ranging from 0 to 15, a medium gray scale range having gray scales ranging from 10 to 180, and a high gray scale range having gray scales ranging from 200 to 255. In this case, based on analysis of the histogram of the picture to be displayed, if the pixel number ratio of the low gray scale range having gray scales ranging from 0 to 15 is above 70%, it may be determined that the picture to be displayed is a picture with the majority of low gray scales. If the pixel number ratio of the medium gray scale range having gray scales ranging from 10 to 180 is above 70%, it may be determined that the picture to be displayed is a picture with majority of the medium gray scales. If the pixel number ratio of the high gray scale range having gray scales ranging from 200 to 255 is above 70%, it may be determined that the picture to be displayed is a picture with majority of high gray scales.

In an example, the preset gray scale ranges may be divided according to the histogram of the picture to be displayed. For example, if the histogram shows that above 70% of pixels of the picture to be displayed are of below 20 gray scales, the range of 0-20 may be determined as a gray scale range, and the range of 21-255 may be determined as another gray scale range. If the histogram shows that above 70% of pixels of the picture to be displayed are of 120-180 gray scales, the range of 0-119 may be determined as a gray scale range, the range of 120-180 may be determined as a gray scale range and the range of 181-255 may be determined as a gray scale range. In another example, the gray scale ranges may also be divided by a preset division method. For example, for any picture to be displayed, the range of 0-45 may be determined as a gray scale range, the range of 46-120 may be determined as a gray scale range, the range of 121-200 may be determined as a gray scale range, and the range of 201-255 may be determined as a gray scale range.

At block 204, a contrast adjustment curve of the picture to be displayed may be determined according to the gray scale distribution information.

The process of block 204 may be referred to the example shown in FIG. 3A, which will not be described in detail here.

At block 205, the contrast of the picture to be displayed may be enhanced according to the contrast adjustment curve.

In this example, when determining whether the mobile device is controlled to switch to the preset display mode, it may be determined by detecting the ambient light luminance or based on whether the preset switching operation is received. Thus, mode switching can be flexible. Moreover, after switching to the present display mode, the contrast may be enhanced automatically based on the gray scale distribution information of the picture to be displayed, so as to effectively improve the display effect of the mobile device, thereby bringing more comfort and readability to a user who uses the mobile device at night.

FIG. 3A is a flowchart illustrating a method of determining a contrast adjustment curve based on gray scale distribution information according to an example of the present disclosure. FIG. 3B is a schematic diagram illustrating a contrast adjustment curve according to an example of the present disclosure. FIG. 3C is a schematic diagram illustrating a contrast adjustment curve according to another example of the present disclosure. FIG. 3D is a schematic diagram illustrating a contrast adjustment curve according to still another example of the present disclosure. As shown in FIG. 3A, the method of determining a contrast adjustment curve based on gray scale distribution information may include the following blocks.

At block 301, at least one of the gray scale ranges of which the pixel number ratio are greater than a preset ratio threshold may be determined as a dominant gray scale range.

In an example, the pixel number ratio in the dominant gray scale range is greater than the preset ratio threshold. The preset ratio threshold may represent a relatively large numerical value, for example, above 40%.

In an example, there may also be more than two dominant gray scale ranges. For example, if a pixel number ratio of a gray scale range having gray scales ranging from 0 to 40 is 40% and a pixel number ratio of another gray scale range having gray scales ranging from 100 to 160 is also 40%, it indicates that a larger number of pixels are present in the two gray scale ranges, and the two gray scale ranges may be determined as the dominant gray scale ranges.

At block 302, the contrast adjustment curve of the picture to be displayed may be determined according to the dominant gray scale range.

In an example, a curve slope of the contrast adjustment curve in the dominant gray scale range may be higher than a curve slope in a non-dominant gray scale range.

When the dominant gray scale range is determined as a first gray scale range, determining the contrast adjustment curve of the picture to be displayed according to the dominant gray scale range may include: determining the contrast adjustment curve of the picture to be displayed as a first contrast adjustment curve. Where, gray scales in the first gray scale range are lower than gray scales in other gray scale ranges. The first contrast adjustment curve is above a reference curve of which a slope is equal to 1 and shaped into an arc bending toward the reference curve. Moreover, when the input gray scale is smaller than a first threshold, a slope of the first contrast adjustment curve increases as the input gray scale increases. When the input gray scale is greater than the first threshold, the slope of the first contrast adjustment curve decreases as the input gray scale increases.

The first threshold may represent an input gray scale corresponding to a point at which the slope is maximal in the first contrast adjustment curve. The first threshold may be set as a median value of the dominant gray scale range. For example, if the dominant gray scale range is of input gray scales ranging from 5 to 25, the first threshold may be set to 15. The first threshold may also be set as an input gray scale corresponding to most pixels. For example, if the dominant gray scale range is of input gray scales ranging from 5 to 25 and the gray scale 17 corresponds to the most pixels, the first threshold may be set to 17. Of course, the first threshold may also be set in other manners.

Referring to FIG. 3B, the straight line denoted as 11B in the FIG. 3B is a reference curve in which an input gray scale may be equal to an output gray scale. The curve denoted as 12 in the FIG. 3B is a contrast adjustment curve which is available when the dominant gray scale range is of relatively low gray scales. In a case that the gray scales of most pixels in the picture to be displayed are relatively low, the luminance and the contrast of pixels having relatively low gray scales may be significantly enhanced with the contrast adjustment curve 12 shown in FIG. 3B, thereby effectively enhancing the contrast of the picture to be displayed.

When the dominant gray scale range is determined as a second preset range, determining the contrast adjustment curve of the picture to be displayed according to the dominant gray scale range may include: determining the contrast adjustment curve of the picture to be displayed as a second contrast adjustment curve. Where, gray scales in the second gray scale range are higher than gray scales in some gray scale ranges and lower than gray scales in other some gray scale ranges. The second contrast adjustment curve is below a reference curve of which a slope is equal to 1 and shaped into an arc bending toward the reference curve when the input gray scale is smaller than a second threshold, and above the reference curve and shaped into an arc bending toward the reference curve when the input gray scale is greater than the second threshold. When the second contrast adjustment curve is below the reference curve, a slope of the second contrast adjustment curve increases as the input gray scale increases. When the second contrast adjustment curve is above the reference curve, the slope of the second contrast adjustment curve decreases as the input gray scale increases.

The second threshold may represent an input gray scale corresponding to a point at which the slope is maximal in the second contrast adjustment curve. The second threshold may be set as a median value of the dominant gray scale range. For example, if the dominant gray scale range is of input gray scales ranging from 100 to 150, the second threshold may be set to 125. The second threshold may also be set as an input gray scale corresponding to the most pixels. For example, if the dominant gray scale range is of input gray scales ranging from 100 to 150 and the gray scale 127 corresponds to the most pixels, the second threshold may be set to 127. Of course, the second threshold may also be set in other manners.

Referring to FIG. 3C, the straight line denoted as 11C in the FIG. 3C is a reference curve in which an input gray scale may be equal to an output gray scale. The curve denoted as 13 in the FIG. 3C is a contrast adjustment curve which is available when the dominant gray scale range is of medium gray scales. In a case that the gray scales of most pixels in the picture to be displayed are medium gray scales, the luminance and the contrast of pixels with the medium gray scales may be significantly enhanced with the contrast adjustment curve 13 shown in FIG. 3C, thereby effectively enhancing the contrast of the picture to be displayed.

When the dominant gray scale range is determined as a third preset range, determining the contrast adjustment curve of the picture to be displayed according to the dominant gray scale range may include: determining the contrast adjustment curve of the picture to be displayed as a third contrast adjustment curve. Where, gray scales in the third gray scale range are higher than gray scales in other gray scale ranges. The third contrast adjustment curve is below a reference curve of which a slope is equal to 1 and shaped into an arc bending toward the reference curve. Moreover, when the input gray scale is smaller than a third threshold, a slope of the third contrast adjustment curve increases as the input gray scale increases. When the input gray scale is greater than the third threshold, the slope of the third contrast adjustment curve decreases as the input gray scale increases.

The third threshold may represent an input gray scale corresponding to a point at which the slope is maximal in the third contrast adjustment curve. The third threshold may be set as a median value of the dominant gray scale range. For example, if the dominant gray scale range is of input gray scales ranging from 190 to 250, the third threshold may be set to 220. The third threshold may also be set as an input gray scale corresponding to the most pixels. For example, if the dominant gray scale range is of input gray scales ranging from 190 to 250 and the gray scale 227 corresponds to the most pixels, the third threshold may be set to 227. Of course, the third threshold may also be set in other manners.

Referring to FIG. 3D, the straight line denoted as 11D in the FIG. 3D is a reference curve in which an input gray scale may be equal to an output gray scale. The curve denoted as 14 in the FIG. 3D is a contrast adjustment curve which is available when the dominant gray scale range is of high gray scales. In a case that the gray scales of most pixels in the picture to be displayed are high gray scales, the luminance and the contrast of pixels with the high gray scales may be significantly enhanced with the contrast adjustment curve 14 shown in FIG. 3D, thereby effectively enhancing the contrast of the picture to be displayed.

It is noted that the contrast adjustment curves 12, 13 and 14 shown in FIG. 3B, FIG. 3C and FIG. 3D are merely illustrative, and the specific contrast adjustment curve may be determined based on the dominant gray scale range of the picture to be displayed. The contrast of pixels within the dominant gray scale range in the picture to be displayed may be significantly enhanced.

Gray scales of a picture to be displayed may also be manually adjusted by the user in different dominant gray scale ranges, and then the contrast adjustment curves corresponding to different dominant gray scale ranges can be generated, as shown in FIG. 4.

In this example, the dominant gray scale range in the picture to be displayed may be determined by analyzing the gray scale distribution information of the picture to be displayed, and then the contrast of the picture to be displayed may be adjusted by selecting a specific contrast adjustment curve based on the dominant gray scale range. Thus, the visibility can be effectively improved.

FIG. 4 is a flowchart illustrating a method of setting a contrast adjustment curve corresponding to different dominant gray scale ranges according to an example of the present disclosure. As shown in FIG. 4, the method may include the following blocks.

At block 401, adjusted gray scales provided by a user for a plurality of pictures to be displayed with different dominant gray scale ranges may be determined.

The adjusted gray scales selected by the user for the plurality of pictures to be displayed in a set time period (e.g., in a month) starting from the time when the user starts to use the mobile device may be calculated, where the plurality of pictures to be displayed may have different dominant gray scale ranges.

At block 402, contrast adjustment curves corresponding to different dominant gray scale ranges may be determined according to the determined adjusted gray scales.

According to the determined adjusted gray scales that are used by the user in different dominant gray scale ranges, contrast adjustment curves corresponding to different dominant gray scale ranges may be generated and updated to the mobile device.

In this example, by determining a gray scale adjustment history provided by the user in different dominant gray scale ranges, the contrast adjustment curve optimal for the user may be generated, so that in the future, the contrast of the picture to be displayed can be adjusted to a contrast optimal for the user according to the contrast adjustment curve.

FIG. 5 is a block diagram illustrating a device for enhancing contrast according to an example of the present disclosure. As shown in FIG. 5, the device for enhancing contrast may include:

a gray scale distribution determining module 510 configured to determine gray scale distribution information of a picture to be displayed with a mobile device when the mobile device operates in a preset display mode, where the preset display mode indicates that a screen luminance is lower than a preset luminance threshold;

a curve determining module 520 configured to determine a contrast adjustment curve of the picture to be displayed according to the gray scale distribution information determined by the gray scale distribution determining module 510; and

a contrast adjusting module 530 configured to enhance contrast of the picture to be displayed according to the contrast adjustment curve determined by the curve determining module 520.

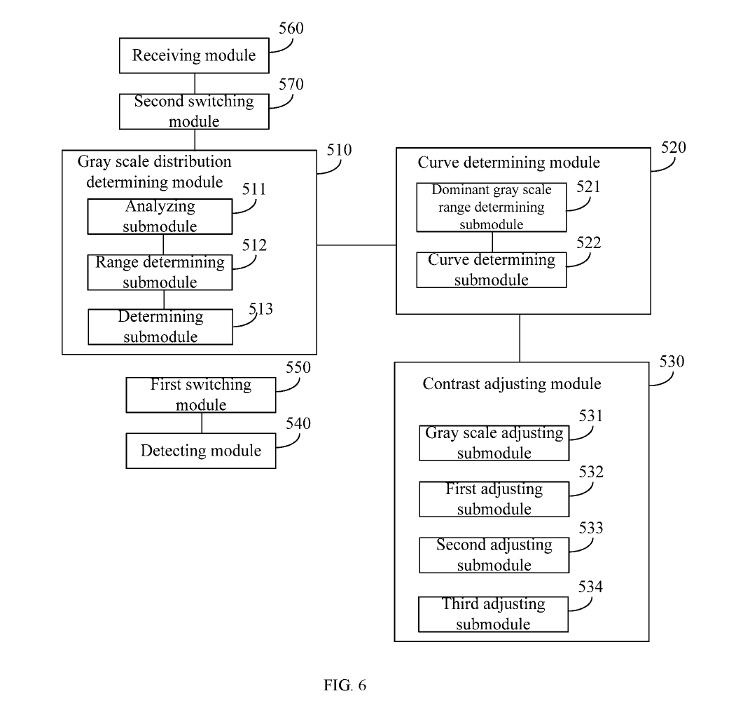

FIG. 6 is a block diagram illustrating a device for enhancing contrast according to another example of the present disclosure. As shown in FIG. 6, on the basis of the above example shown in FIG. 5, the device for enhancing contrast may also include: a detecting module 540 configured to detect an ambient light luminance; and a first switching module 550 configured to control the mobile device to switch to the preset display mode when the detecting module 540 detects that the ambient light luminance is lower than a preset ambient luminance.

In an example, the device for enhancing contrast may also include: a receiving module 560 configured to receive a preset switching operation triggered by a user via a physical button or a touch screen of the mobile device; and a second switching module 570 configured to control the mobile device to switch to the preset display mode according to the preset switching operation received by the receiving module 560.

In an example, the gray sale distribution determining module 510 may include: an analyzing submodule 511 configured to analyze a histogram of the picture to be displayed; a range determining submodule 512 configured to determine a plurality of gray scale ranges in the picture to be displayed; and a determining submodule 513 configured to determine a pixel number ratio of each of the plurality of gray scale ranges in the picture to be displayed according to the histogram to obtain the gray scale distribution information of the picture to be displayed, where the pixel number ratio of the gray scale range is a ratio of a number of pixels having gray scale within the gray scale range in the picture to be displayed with respect to a total number of pixels in the picture to be displayed.

In an example, the curve determining module 520 may include: a dominant gray scale range determining submodule 521 configured to determine at least one of the gray scale ranges of which the pixel number ratio is greater than a preset ratio threshold as a dominant gray scale range; and a curve determining submodule 522 configured to determine the contrast adjustment curve of the picture to be displayed according to the dominant gray scale range, where a horizontal axis of the contrast adjustment curve represents an input gray scale, a vertical axis of the contrast adjustment curve represents an output gray scale, and a curve slope of the contrast adjustment curve in the dominant gray scale range is greater than a curve slope in a non-dominant gray scale range.

The contrast adjusting module 530 may include: a gray scale adjusting submodule 531 configured to take a gray scale of each of the pixels of the picture to be displayed as an input gray scale, determine an output gray scale corresponding to the input gray scale in the contrast adjustment curve, and adjust the gray scale of each of the pixels to be the determined corresponding output gray scale to enhance the contrast of the picture to be displayed.

In an example, the contrast adjusting module 530 may include: a first adjusting submodule 532 configured to when the dominant gray scale range is determined as a first gray scale range, determine the contrast adjustment curve of the picture to be displayed as a first contrast adjustment curve. Where gray scales in the first gray scale range are lower than gray scales in other gray scale ranges. The first contrast adjustment curve is above a reference curve of which a slope is equal to 1 and shaped into an arc bending toward the reference curve. When the input gray scale is smaller than a first threshold, a slope of the first contrast adjustment curve increases as the input gray scale increases. When the input gray scale is greater than the first threshold, the slope of the first contrast adjustment curve decreases as the input gray scale increases.

In an example, the contrast adjusting module 530 may include: a second adjusting submodule 533 configured to when the dominant gray scale range is determined as a second gray scale range, determine the contrast adjustment curve of the picture to be displayed as a second contrast adjustment curve. Where gray scales in the second gray scale range are higher than gray scales in some gray scale ranges and lower than gray scales in other some gray scale ranges. The second contrast adjustment curve is below a reference curve of which a slope is equal to 1 and shaped into an arc bending toward the reference curve when the input gray scale is smaller than a second threshold, and above the reference curve and shaped into an arc bending toward the reference curve when the input gray scale is greater than the second threshold. When the second contrast adjustment curve is below the reference curve, a slope of the second contrast adjustment curve increases as the input gray scale increases. When the second contrast adjustment curve is above the reference curve, the slope of the second contrast adjustment curve decreases as the input gray scale increases.

In an example, the contrast adjusting module 530 may include: a third adjusting submodule 534 configured to when the dominant gray scale range is determined as a third gray scale range, determine the contrast adjustment curve of the picture to be displayed as a third contrast adjustment curve. Where gray scales in the third gray scale range are higher than gray scales in other gray scale ranges. The third contrast adjustment curve is below a reference curve of which a slope is equal to 1 and shaped into an arc bending toward the reference curve. When the input gray scale is smaller than a third threshold, a slope of the third contrast adjustment curve increases as the input gray scale increases. When the input gray scale is greater than the third threshold, the slope of the third contrast adjustment curve decreases as the input gray scale increases.

Details of the implementation process of the functions and effects of different modules in the above-described device may be seen from the implementation process of corresponding blocks in the above-described method, which will not be redundantly described herein.

Since the device examples substantially correspond to the method examples, a reference may be made to part of the descriptions of the method examples for the related part. The device examples described above are merely illustrative, where the units described as separate members may be or not be physically separated, and the members displayed as units may be or not be physical units, i.e., may be located in one place, or may be distributed to a plurality of network units. Part or all of the modules may be selected according to actual requirements to implement the objectives of the solutions in the examples. Those of ordinary skill in the art may understand and carry out them without creative work.

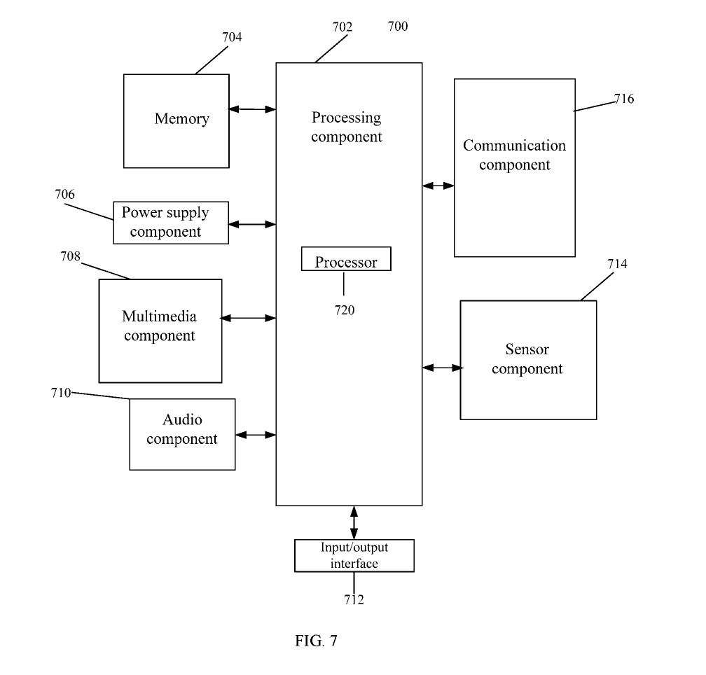

FIG. 7 is a diagram illustrating a hardware structure of a device for enhancing contrast according to an example of the present disclosure. For example, the device 700 may be a mobile device, such as a table computer, a smart phone, a smart camera, or the like.

Referring to FIG. 7, the device 700 may include one or more of the following components: a processing component 702, a memory 704, a power supply component 706, a multimedia component 708, an audio component 710, an Input/Output (I/O) interface 712, a sensor component 714, and a communication component 716.

The processing component 702 generally controls overall operations of the device 700, such as operations associated with display, phone calling, data communication, camera operation and recording operation. The processing component 702 may include one or more processors 720 for executing instructions to complete all or part of blocks of the above method. Besides, the processing component 702 may include one or more modules to facilitate interactions between the processing component 702 and other components. For example, the processing component 702 may include a multimedia module to facilitate the interaction between the multimedia component 708 and the processing component 702.

The memory 704 may be configured to store different types of data to support the operations of the device 700. Examples of such data include instructions of any application or method on the device 700, contact data, messages, pictures, and so on. The memory 704 may be implemented by any type of volatile or non-volatile storage device or a combination thereof, such as a Static Random Access Memory (SRAM), an Electrically Erasable Programmable Read-Only Memory (EEPROM), an Electrically Programmable Read-Only-Memory (EPROM), a Programmable Read-Only-Memory (PROM), a Read-Only Memory (ROM), a magnetic memory, a flash memory, a magnetic disk or an optical disk.

The power supply component 706 may provide power for the different components of the device 700. The power supply component 706 may include a power management system, one or more power supplies, and other components associated with generating, managing and distributing power for the device 700.

The multimedia component 708 includes a screen providing an output interface between the device 700 and a user. In some examples, the screen may include a Liquid Crystal Display (LCD) and/or a Touch Panel (TP). If the screen includes a touch panel, the screen may be implemented as a touch screen to receive an input signal from the user. The touch panel includes one or more touch sensors to sense touches, slips and gestures on the touch panel. The touch sensor may not only sense the boundary of a touch or slip action but also sense a duration and a pressure associated with the touch or slip action. In some examples, the multimedia component 708 may include a front camera and/or a rear camera. When the device 700 is in an operating mode, such as in a photographing mode or a video mode, the front camera and/or the rear camera may receive external multimedia data. Each of the front camera and the rear camera may be a fixed optical lens system or have focal length and optical zooming capability.

The audio component 710 is configured to output and/or input an audio signal. For example, the audio component 710 may include a microphone (MIC). When the device 700 is in an operating mode, such as, a call mode, a recording mode or a voice recognition mode, the microphone is configured to receive an external audio signal. The received audio signal may be further stored in the memory 704 or sent via the communication component 716. In some examples, the audio component 710 also includes a speaker for outputting an audio signal.

The I/O interface 712 may provide an interface between the processing component 702 and a peripheral interface module. The peripheral interface module may be a keyboard, click wheel, a button and the like. Such buttons may include but not limited to: a home button, a volume button, a starting button and a locking button.

The sensor component 714 may include one or more sensors to provide status assessments of various aspects for the device 700. For example, the sensor component 714 may detect the on/off state of the device 700, and relative positioning of components, for example, the component is a display and a keypad of the device 700. The sensor component 714 may also detect a change in position of the device 700 or one component of the device 700, a presence or absence of the contact between the user and the device 700, an orientation or an acceleration/deceleration of the device 700 and a change in temperature of the device 700. The sensor component 714 may include a proximity sensor configured to detect presence of a nearby object without any physical contact. The sensor component 714 may also include an optical sensor, such as a CMOS or CCD image sensor to be used in imaging application. In some examples, the sensor component 714 may also include an acceleration sensor, a gyroscope sensor, a magnetic sensor, a distance sensor, a pressure sensor, or a temperature sensor.

The communication component 716 may be configured to facilitate wired or wireless communication between the device 700 and other devices. The device 700 may access a wireless network based on a communication standard, such as WIFI, 2G or 3G or a combination thereof. In an example, the communication component 716 may receive a broadcast signal or broadcast-related information from an external broadcast management system via a broadcast channel. In an example, the communication component 716 may also include a Near Field Communication (NFC) module to facilitate short-range communications. For example, the NFC module may be implemented based on a Radio Frequency Identification (RFID) technology, an Infrared Data Association (IrDA) technology, an Ultra Wide Band (UWB) technology, a Bluetooth (BT) technology and other technology.

In an example, the device for enhancing contrast may be interpreted as machine-executable instructions stored on a machine-readable storage medium. The device 700 may be implemented by one or more of an Application Specific Integrated Circuit (ASIC), a Digital Signal Processor (DSP), a Digital Signal Processor (DSPD), a Programmable Logic Device (PLD), a Field Programmable Gate Array (FPGA), a controller, a microcontroller, a microprocessor or other electronic units. A processor 720 of the device 700 may be caused by reading the machine-executable instructions stored on the machine-readable storage medium to execute the above method of enhancing contrast.

In an example, the processor 720 is caused by the machine-executable instructions to:

determine gray scale distribution information of a picture to be displayed with a mobile device when the mobile device operates in a preset display mode, wherein the preset display mode indicates that a screen luminance is lower than a preset luminance threshold;

determine a contrast adjustment curve of the picture to be displayed according to the gray scale distribution information; and

enhance contrast of the picture to be displayed according to the contrast adjustment curve.

In an example, there is also provided a non-transitory computer-readable storage medium including instructions, for example, a memory 704 including instructions. Such instructions may be executed by a processor 720 of the device 700 to perform the above method. For example, the non-transitory computer-readable storage medium may be a Read-Only Memory (ROM), a Random Access Memory (RAM), a CD-ROM, a magnetic tape, a floppy disk, an optical data storage device, and the like.

The present disclosure provides a method and a device for enhancing contrast to allow a mobile device to adaptively enhance contrast of a displayed picture and improve readability.

According to a first aspect of the present disclosure, a method of enhancing contrast is provided. The method may include:

determining gray scale distribution information of a picture to be displayed with a mobile device when the mobile device operates in a preset display mode, wherein the preset display mode indicates that a screen luminance is lower than a preset luminance threshold;

determining a contrast adjustment curve of the picture to be displayed according to the gray scale distribution information; and

enhancing contrast of the picture to be displayed according to the contrast adjustment curve.

According to a second aspect of the present disclosure, a device for enhancing contrast is provided, the device may include:

a processor; and

a machine-readable storage medium;

wherein by reading and executing machine-executable instructions stored on the machine-readable storage medium, the processor is caused to:

determine gray scale distribution information of a picture to be displayed with a mobile device when the mobile device operates in a preset display mode, wherein the preset display mode indicates that a screen luminance is lower than a preset luminance threshold;

determine a contrast adjustment curve of the picture to be displayed according to the gray scale distribution information; and

enhance contrast of the picture to be displayed according to the contrast adjustment curve.

When the mobile device operates in the preset display mode, for example, the screen luminance is lower than the preset luminance threshold, the contrast adjustment curve of the picture to be displayed with the mobile device may be automatically determined so as to enhance the contrast of the picture to be displayed, thereby improving readability of the displayed content.

Moreover, when determining whether the mobile device is controlled to switch to the preset display mode, it may be determined by detecting an ambient light luminance or based on whether a preset switching operation is received. In this way, mode switching can be flexible. Furthermore, after switching to the present display mode, the contrast may be enhanced automatically based on the displayed picture, so as to improve display effect of the mobile device, thereby bringing more comfort and readability to the user who uses the mobile device at night.

The dominant gray scale range in the picture to be displayed may be determined by analysing the gray scale distribution information of the picture to be displayed, and then the contrast of the picture to be displayed may be adjusted by selecting a specific contrast adjustment curve. Thus, the visibility can be effectively improved.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure being indicated by the following claims.

It is to be understood that the present disclosure is not limited to the precise structure described above and shown in the accompanying drawings, and that various modifications and changes may be made without departing from the scope thereof. The scope of the present disclosure is limited only by the appended claims.

1. A method of enhancing contrast, comprising:
determining gray scale distribution information of a picture to be displayed on a mobile device when the mobile device operates in a preset display mode, wherein, in the preset display mode, the mobile device has a screen luminance that is lower than a preset luminance threshold;
determining a contrast adjustment curve of the picture to be displayed according to the gray scale distribution information; and
enhancing contrast of the picture to be displayed according to the contrast adjustment curve.

2. The method of claim 1, further comprising:
detecting an ambient light luminance; and
when the ambient light luminance is lower than a preset ambient luminance, controlling the mobile device to operate in the preset display mode.

3. The method of claim 1, further comprising:
receiving a preset switching operation triggered via a physical button of the mobile device; and
controlling the mobile device to operate in the preset display mode according to the preset switching operation.

4. The method of claim 1, further comprising:
receiving a preset switching operation triggered via a touch screen of the mobile device; and
controlling the mobile device to operate in the preset display mode according to the preset switching operation.

5. The method of claim 1, wherein determining the gray scale distribution information of the picture to be displayed comprises:
analyzing a histogram of the picture to be displayed;
determining a plurality of gray scale ranges in the picture to be displayed; and
determining a pixel number ratio of each of the plurality of gray scale ranges in the picture to be displayed according to the histogram to obtain the gray scale distribution information of the picture to be displayed, wherein the pixel number ratio of the gray scale range is a ratio of a number of pixels having a gray scale within the gray scale range in the picture to be displayed with respect to a total number of pixels in the picture to be displayed.

6. The method of claim 5, wherein determining the contrast adjustment curve of the picture to be displayed according to the gray scale distribution information comprises:
determining at least one of the gray scale ranges as a dominant gray scale range, wherein the at least one of the gray scale ranges has the pixel number ratio that is greater than a preset ratio threshold; and
determining the contrast adjustment curve of the picture to be displayed according to the dominant gray scale range, wherein a horizontal axis of the contrast adjustment curve represents an input gray scale, a vertical axis of the contrast adjustment curve represents an output gray scale, and a curve slope of the contrast adjustment curve in the dominant gray scale range is greater than a curve slope in a non-dominant gray scale range.

7. The method of claim 6, wherein enhancing the contrast of the picture to be displayed according to the contrast adjustment curve comprises:
taking a gray scale of each of the pixels of the picture to be displayed as the input gray scale;
determining the output gray scale corresponding to the input gray scale in the contrast adjustment curve; and
adjusting the gray scale of each of the pixels to be the determined corresponding output gray scale to enhance the contrast of the picture to be displayed.

8. The method of claim 6, wherein determining the contrast adjustment curve of the picture to be displayed according to the dominant gray scale range comprises:
when the dominant gray scale range is determined as a first gray scale range, determining the contrast adjustment curve of the picture to be displayed as a first contrast adjustment curve, wherein
gray scales in the first gray scale range are lower than gray scales in gray scale ranges excluding the first gray scale range;
the first contrast adjustment curve is above a reference curve of which a slope is equal to 1 and is shaped into an arc bending toward the reference curve;
when the input gray scale is smaller than a first threshold, a slope of the first contrast adjustment curve increases as the input gray scale increases; and
when the input gray scale is greater than the first threshold, the slope of the first contrast adjustment curve decreases as the input gray scale increases.

9. The method of claim 6, wherein determining the contrast adjustment curve of the picture to be displayed according to the dominant gray scale range comprises:
when the dominant gray scale range is determined as a second gray scale range, determining the contrast adjustment curve of the picture to be displayed as a second contrast adjustment curve, wherein
gray scales in the second gray scale range are in the middle of gray scales in gray scale ranges excluding the second grey scale range;
the second contrast adjustment curve is below a reference curve of which a slope is equal to 1 and is shaped into an arc bending toward the reference curve when the input gray scale is smaller than a second threshold, and is above the reference curve and is shaped into an arc bending toward the reference curve when the input gray scale is greater than the second threshold;
when the second contrast adjustment curve is below the reference curve, a slope of the second contrast adjustment curve increases as the input gray scale increases; and
when the second contrast adjustment curve is above the reference curve, the slope of the second contrast adjustment curve decreases as the input gray scale increases.

10. The method of claim 6, wherein determining the contrast adjustment curve of the picture to be displayed according to the dominant gray scale range comprises:
when the dominant gray scale range is determined as a third gray scale range, determining the contrast adjustment curve of the picture to be displayed as a third contrast adjustment curve, wherein
gray scales in the third gray scale range are higher than gray scales in gray scale ranges excluding the third grey scale range;
the third contrast adjustment curve is below a reference curve of which a slope is equal to 1 and is shaped into an arc bending toward the reference curve;
when the input gray scale is smaller than a third threshold, a slope of the third contrast adjustment curve increases as the input gray scale increases; and
when the input gray scale is greater than the third threshold, the slope of the third contrast adjustment curve decreases as the input gray scale increases.

11. A device for enhancing contrast, comprising:
a processor; and
a non-transitory machine-readable storage medium storing instructions are executable by the processor;
wherein the processor is configured to:
determine gray scale distribution information of a picture to be displayed on a mobile device when the mobile device operates in a preset display mode, wherein, in the preset display mode, the mobile device has a screen luminance that is lower than a preset luminance threshold;
determine a contrast adjustment curve of the picture to be displayed according to the gray scale distribution information; and
enhance contrast of the picture to be displayed according to the contrast adjustment curve.

12. The device of claim 11, wherein the processor is further configured to:
detect an ambient light luminance; and
when the ambient light luminance is lower than a preset ambient luminance, control the mobile device to operate in the preset display mode.

13. The device of claim 11, wherein the processor is further configured to:
receive a preset switching operation triggered via a physical button of the mobile device; and
control the mobile device to operate in the preset display mode according to the preset switching operation.

14. The device of claim 11, wherein the processor is further configured to:
receive a preset switching operation triggered via a touch screen of the mobile device; and
control the mobile device to operate in the preset display mode according to the preset switching operation.

15. The device of claim 11, wherein when determining the gray scale distribution information of the picture to be displayed, the processor is further caused by the machine-executable instructions to:
analyze a histogram of the picture to be displayed;
determine a plurality of gray scale ranges in the picture to be displayed; and
determine a pixel number ratio of each of the plurality of gray scale ranges in the picture to be displayed according to the histogram to obtain the gray scale distribution information of the picture to be displayed, wherein the pixel number ratio of the gray scale range is a ratio of a number of pixels having gray scale within the gray scale range in the picture to be displayed with respect to a total number of pixels in the picture to be displayed.

16. The device of claim 15, wherein the processor configured to determine the contrast adjustment curve of the picture to be displayed according to the gray scale distribution information is further configured to:
determine at least one of the gray scale ranges as a dominant gray scale range, wherein the at least one of the gray scale ranges has the pixel number ratio that is greater than a preset ratio threshold; and
determine the contrast adjustment curve of the picture to be displayed according to the dominant gray scale range, wherein a horizontal axis of the contrast adjustment curve represents an input gray scale, a vertical axis of the contrast adjustment curve represents an output gray scale, and a curve slope of the contrast adjustment curve in the dominant gray scale range is greater than a curve slope in a non-dominant gray scale range.

17. The device of claim 16, wherein the processor configured to enhance the contrast of the picture to be displayed according to the contrast adjustment curve is further configured to:
take a gray scale of each of the pixels of the picture to be displayed as the input gray scale;
determine the output gray scale corresponding to the input gray scale in the contrast adjustment curve; and
adjust the gray scale of each of the pixels to be the determined corresponding output gray scale to enhance the contrast of the picture to be displayed.

18. The device of claim 16, wherein the processor configured to determine the contrast adjustment curve of the picture to be displayed according to the dominant gray scale range is further configured to:
when the dominant gray scale range is determined as a first gray scale range, determine the contrast adjustment curve of the picture to be displayed as a first contrast adjustment curve, wherein
gray scales in the first gray scale range are lower than gray scales in gray scale ranges excluding the first grey scale range;
the first contrast adjustment curve is above a reference curve of which a slope is equal to 1 and is shaped into an arc bending toward the reference curve;
when the input gray scale is smaller than a first threshold, a slope of the first contrast adjustment curve increases as the input gray scale increases; and
when the input gray scale is greater than the first threshold, the slope of the first contrast adjustment curve decreases as the input gray scale increases.

19. The device of claim 16, wherein the processor configured to determine the contrast adjustment curve of the picture to be displayed according to the dominant gray scale range is further configured to:
when the dominant gray scale range is determined as a second gray scale range, determine the contrast adjustment curve of the picture to be displayed as a second contrast adjustment curve, wherein
gray scales in the second gray scale range are in the middle of gray scales in gray scale ranges excluding the second grey scale range;
the second contrast adjustment curve is below a reference curve of which a slope is equal to 1 and is shaped into an arc bending toward the reference curve when the input gray scale is smaller than a second threshold, and is above the reference curve and is shaped into an arc bending toward the reference curve when the input gray scale is greater than the second threshold;
when the second contrast adjustment curve is below the reference curve, a slope of the second contrast adjustment curve increases as the input gray scale increases; and
when the second contrast adjustment curve is above the reference curve, the slope of the second contrast adjustment curve decreases as the input gray scale increases.

20. The device of claim 16, wherein the processor configured to determine the contrast adjustment curve of the picture to be displayed according to the dominant gray scale range is further configured to:
when the dominant gray scale range is determined as a third gray scale range, determine the contrast adjustment curve of the picture to be displayed as a third contrast adjustment curve, wherein
gray scales in the third gray scale range are higher than gray scales in gray scale ranges excluding the third grey scale range;
the third contrast adjustment curve is below a reference curve of which a slope is equal to 1 and shaped into an arc bending toward the reference curve;
when the input gray scale is smaller than a third threshold, a slope of the third contrast adjustment curve increases as the input gray scale increases; and
when the input gray scale is greater than the third threshold, the slope of the third contrast adjustment curve decreases as the input gray scale increases.
